(19) United States
(12) Patent Application Publication
(10) Pub. No.: US 2019/0279460 A1
(43) Pub. Date: Sep. 12, 2019

(54) NON-TRANSITORY COMPUTER-READABLE RECORDING MEDIUM STORING USE CONTROL PROGRAM, USE CONTROL APPARATUS, AND USE CONTROL METHOD

(71) Applicant: FUJITSU LIMITED, Kawasaki-shi (JP)

(72) Inventor: SHINYA ITO, Chiba (JP)

(73) Assignee: FUJITSU LIMITED, Kawasaki-shi (JP)

(21) Appl. No.: 16/278,884

(22) Filed: Feb. 19, 2019

(30) Foreign Application Priority Data
Mar. 8, 2018 (JP) 2018-042373

(51) Int. Cl. G07F 17/32

(52) U.S. Cl. CPC G07F 17/3223; G07F 17/323; G07F 17/3241; G07F 17/3239; G07F 17/3255

(57) ABSTRACT

A computer-readable recording medium stores therein a control program for causing a computer to execute a process of executing control to enable use of a facility service using a mobile terminal corresponding to a visitor in response to an entry detection signal of the visitor to a facility; and executing control to disable use of the facility service using the mobile terminal corresponding to the visitor in response to an exit detection signal of the visitor from the facility.

### CROSS-REFERENCE TO RELATED APPLICATION

This application is based upon and claims the benefit of priority of the prior Japanese Patent Application No. 2018-42373, filed on Mar. 8, 2018, the entire contents of which are incorporated herein by reference.

### FIELD

The embodiment discussed herein is related to a non-transitory computer-readable recording medium storing a use control program, a use control apparatus, and a use control method.

### BACKGROUND

For example, major countries such as industrialized countries have casino facilities that provide casino services such as table games and slot machines to users. In such a casino facility, for example, casino services are provided by operating a live multi-gaming system.

This live multi-gaming system is a system that allows a user to participate in a game while viewing a live video (for example, video of a dealer) displayed on a terminal without facing a dealer. In this way, the user may participate in the game without being limited by the number of seats and the like of the table where the game is performed. In addition, the user may participate in a plurality of games concurrently by switching the live video displayed on the terminal at any time.

Here, in the above-described casino facility, for example, there is a case where the area where casino services may be provided is limited by law due to the necessity to limit excessive use of casino services by users. Therefore, in such a casino facility, for example, when providing casino services by using a live multi-gaming system, there is a case where a user uses a mobile terminal such as a smartphone or a tablet. In this way, in casino facilities, even in the case of providing casino services using a live multi-gaming system, it is optional to arrange a stationary terminal and more users may enter the area where the casino services may be provided (see, for example, Japanese Laid-open Patent Publication No. 2016-076230).

### SUMMARY

According to an aspect of the embodiments, a non-transitory computer-readable recording medium stores therein a control program for causing a computer to execute a process of executing control to enable use of a facility service using a mobile terminal corresponding to a visitor in response to an entry detection signal of the visitor to a facility; and executing control to disable use of the facility service using the mobile terminal corresponding to the visitor in response to an exit detection signal of the visitor from the facility.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration of an information processing system;

FIG. 2 is a diagram illustrating a hardware configuration of the information processing system;

FIG. 3 is a block diagram of functions of the information processing system;

FIG. 4 is a flowchart illustrating an outline of use control processing in a first embodiment;

FIG. 5 is a diagram illustrating an outline of use control processing in the first embodiment;

FIG. 6 is a diagram illustrating an outline of use control processing in the first embodiment;

FIG. 7 is a flowchart illustrating the details of use control processing in the first embodiment;

FIG. 8 is a flowchart illustrating the details of use control processing in the first embodiment;

FIG. 9 is a flowchart illustrating the details of use control processing in the first embodiment;

FIG. 10 is a flowchart illustrating the details of use control processing in the first embodiment;

FIG. 11 is a flowchart illustrating the details of use control processing in the first embodiment;

FIG. 12 is a flowchart illustrating the details of use control processing in the first embodiment;

FIG. 13 is a flowchart illustrating the details of use control processing in the first embodiment;

FIG. 14 is a flowchart illustrating the details of use control processing in the first embodiment;

FIG. 15 is a flowchart illustrating the details of use control processing in the first embodiment;

FIG. 16 is a flowchart illustrating the details of use control processing in the first embodiment;

FIG. 17 is a flowchart illustrating the details of use control processing in the first embodiment;

FIG. 18 is a flowchart illustrating the details of use control processing in the first embodiment;

FIG. 19 is a flowchart illustrating the details of use control processing in the first embodiment;

FIG. 20 is a flowchart illustrating the details of use control processing in the first embodiment;

FIG. 21 is a diagram illustrating a specific example of user information;

FIG. 22 is a diagram illustrating a specific example of upper limit information;

FIG. 23 is a diagram illustrating a specific example of entry and exit information;

FIG. 24 is a diagram illustrating a specific example of terminal rental information;

FIG. 25 is a diagram illustrating a specific example of account information; and

FIG. 26 is a diagram illustrating a specific example of deposit and withdrawal history information.

### DESCRIPTION OF EMBODIMENTS

For an example, in the case of providing a casino service using a mobile terminal as described above, it may be possible to use the casino service from outside the casino facility depending on the connection status of wireless communication or the like. Therefore, in the casino facility, there is a case that it is not possible to provide a casino service by using a mobile terminal because of necessity of limiting use of the casino service from outside the casino facility.

Configuration of Information Processing System

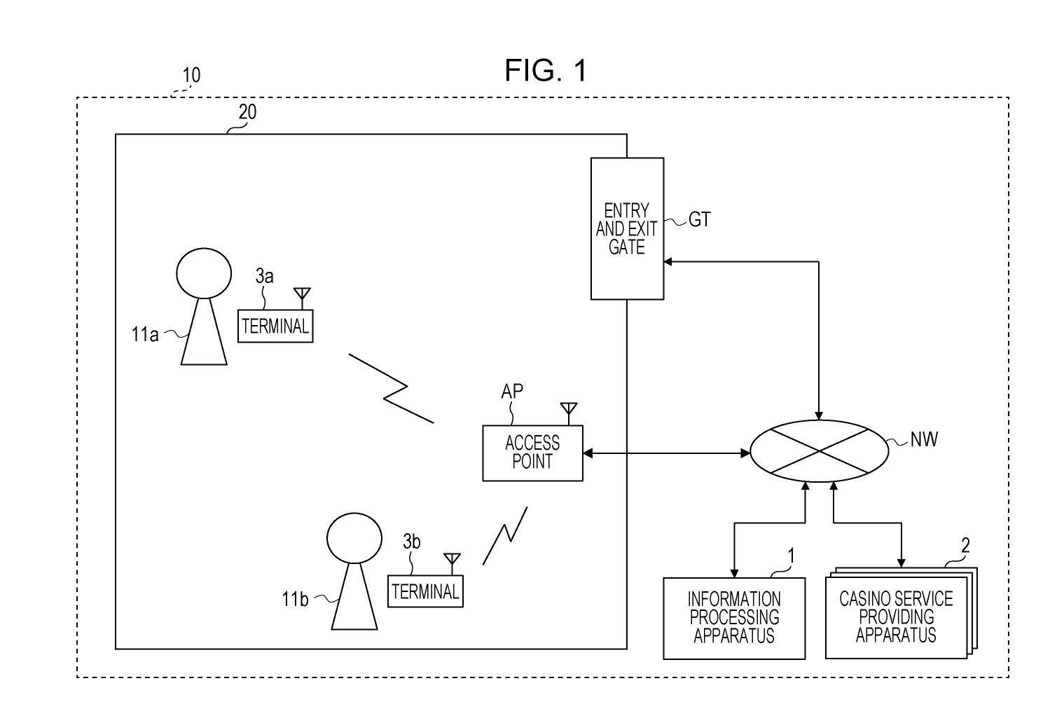

FIG. 1 is a diagram illustrating an overall configuration of an information processing system 10. The information processing system 10 illustrated in FIG. 1 includes an information processing apparatus 1 configured with one or more physical machines, a casino service providing apparatus 2 configured with one or more physical machines, and a mobile terminal 3a and a mobile terminal 3b used by a user 11a and a user 11b entering a casino facility 20 via an entry and exit gate GT (for example, Penta-Ocean Introduced Entering/Leaving managing system with Color bit codes provided by Penta-Ocean Construction Co., Ltd. is known), respectively. Hereinafter, the user 11a and the user 11b are collectively referred to as a user 11, and the mobile terminal 3a and the mobile terminal 3b are collectively referred to as a mobile terminal 3, respectively. The mobile terminal 3 may be the mobile terminal 3 possessed by the user 11 himself or herself or may be the mobile terminal 3 rented out at the casino facility 20.

In the example illustrated in FIG. 1, the mobile terminal 3 performs radio communication with the Wireless LAN access point AP by using Wi-Fi (Trademark: Wireless Fidelity) or the like, for example, but any communication means other than Wi-Fi may be used. In addition, the information processing apparatus 1, the casino service providing apparatus 2, and the Wireless LAN access point AP communicate with each other (for example, wired communication) by way of a network NW.

Then, the casino service providing apparatus 2 executes processing for providing the casino service to the user 11. Specifically, in the casino service providing apparatus 2, the live multi-gaming system operates.

In addition, the information processing apparatus 1 executes control to enable use of the casino service using the mobile terminal 3 by the user 11 whose entry has been detected in response to detection of entry of the user 11 into the casino facility 20. Specifically, in a case where a signal (“entry detection signal”) indicating that entry of the user 11 has been detected is received at the entry and exit gate GT, the information processing apparatus 1 permits login (for example, login via the mobile terminal 3) to the casino service providing apparatus 2 by the user 11 whose entry has been detected.

Furthermore, the information processing apparatus 1 executes control to disable use of the casino service using the mobile terminal 3 by the user 11 whose exit has been detected in response to detection of exit of the user 11 from the casino facility 20. Specifically, in a case where a signal (“exit detection signal”) indicating that exit of the user 11 has been detected is received at the entry and exit gate GT, the information processing apparatus 1 prohibits login (for example, login via the mobile terminal 3) to the casino service providing apparatus 2 by the user 11 whose exit has been detected.

That is, the information processing apparatus 1 enables use of the casino service via the mobile terminal 3 by the user 11, for example, only while the user 11 enters the casino facility 20 until exiting the casino facility 20.

In this way, even in the case where the casino service using the mobile terminal 3 is provided at the casino facility 20, the information processing apparatus 1 may avoid occurrence of situations in which it is possible to use the casino service from outside the casino facility 20.

Hardware Configuration of Information Processing System

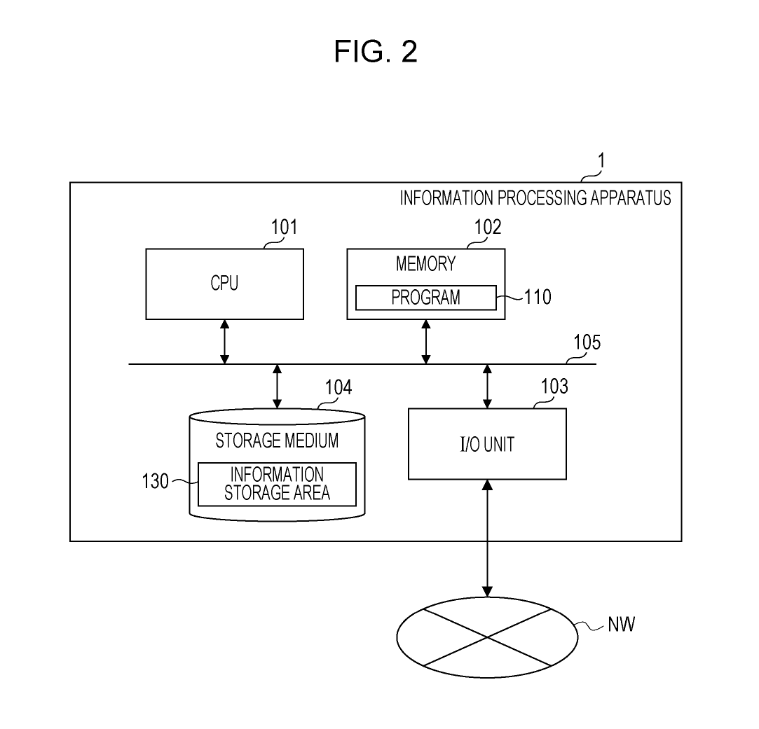

Next, the hardware configuration of the information processing system 10 will be described. FIG. 2 is a diagram illustrating a hardware configuration of the information processing system 10. Specifically, FIG. 2 is a diagram illustrating the hardware configuration of the information processing apparatus 1.

As illustrated in FIG. 2, the information processing apparatus 1 includes a CPU 101 as a processor, a memory 102, an external interface (hereinafter, also referred to as I and O unit) 103, and a storage medium 104. The respective units are connected to each other via a bus 105.

The storage medium 104 stores, for example, a program 110 for performing processing (hereinafter, also referred to as use control processing) of controlling use of a casino service using a mobile terminal 3 in a program storage area (not illustrated) in the storage medium 104. The storage medium 104 may be, for example, a hard disk drive) (HDD).

In addition, the storage medium 104 includes, for example, a storage unit 130 (hereinafter, also referred to as information storage area 130) for storing information used for performing use control processing. The storage medium is called as a memory.

The CPU 101 performs the use control processing by executing the program 110 loaded from the storage medium 104 into the memory 102.

The external interface 103 communicates with the casino service providing apparatus 2 and a Wireless LAN access point AP via the network NW, for example.

Functions of Information Processing System

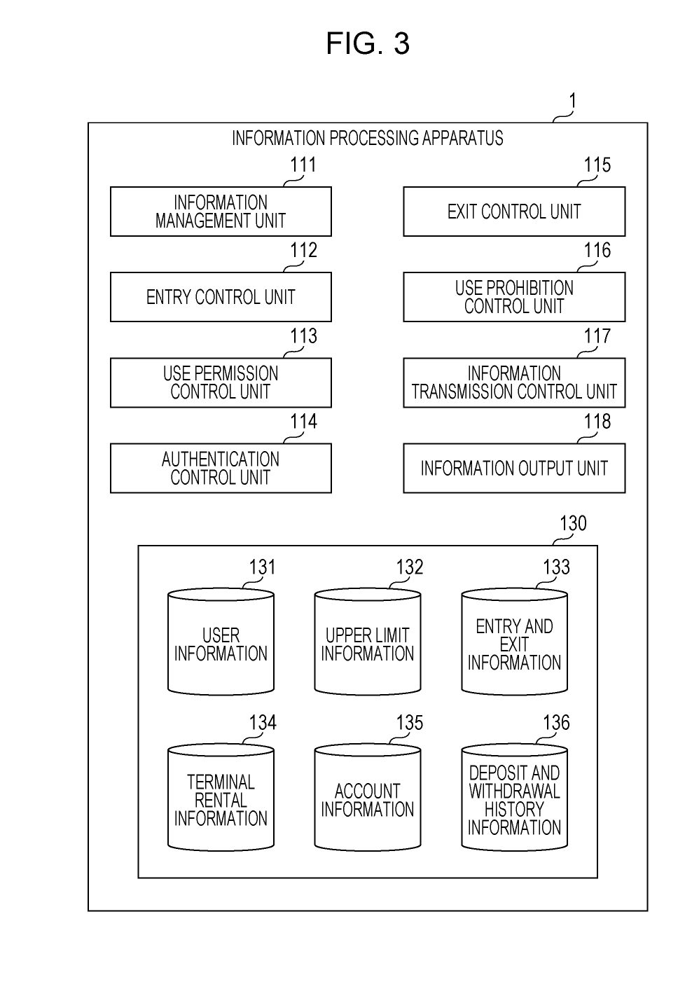

Next, functions of an information processing system 10 will be described. FIG. 3 is a block diagram of functions of the information processing system 10.

The hardware such as the CPU 101, the memory 102 and the like and the program 110 work cooperatively, and therefore, as illustrated in FIG. 3, the information processing apparatus 1 realizes various functions including an information management unit 111, an entry control unit 112, a use permission control unit 113, an authentication control unit 114, an exit control unit 115, a use prohibition control unit 116, an information transmission control unit 117, and an information output unit 118.

As illustrated in FIG. 3, the information processing apparatus 1 stores user information 131, the upper limit information 132, entry and exit information 133, terminal rental information 134, account information 135, and deposit and withdrawal history information 136 as information in the information storage area 130.

For example, in a case where the user 11 of the casino facility 20 inputs the user information 131 and the upper limit information 132, the information management unit 111 stores the input user information 131 and the upper limit information 132 in the information storage area 130.

The user information 131 is information for identifying each user 11 who uses the casino service at the casino facility 20. That is, the user information 131 is, for example, information for identifying the user 11 who is allowed to enter the casino facility 20. Specifically, the user information 131 may be, for example, information input by the user 11 himself or herself before the user 11 enters the casino facility 20.

In addition, the upper limit information 132 is information indicating the amount of money that each user 11 may use when receiving a casino service at the casino facility 20. That is, the upper limit information 132 is information input for the purpose of limiting excessive use of the casino service by each user 11. Specifically, the upper limit information 132 may be, for example, information input by a relative of the user 11 or the like before the user 11 enters the casino facility 20.

In a case where each user 11 makes an entry request to the casino facility 20 at the entry and exit gate GT, the entry control unit 112 refers to the user information 131 stored in the information storage area 130 and determines whether or not to permit entry of the user 11 who has made the entry request. Then, in a case where the entry of the user 11 is permitted, the entry control unit 112 stores information indicating that the entry of the user 11 is permitted as at least a part of the entry and exit information 133 in the information storage area 130, for example.

The use permission control unit 113 executes control to enable the use of the casino service using the mobile terminal 3 by the user 11 (user 11 who has entered the casino facility 20) whose entry has been permitted by the entry control unit 112. Specifically, for example, the use permission control unit 113 set a state in which the user 11 whose entry has been permitted by the entry control unit 112 may login to the casino service providing apparatus 2 via the mobile terminal 3.

In a case where the user 11 inputs valid authentication information (for example, authentication information including the user ID and password of the user 11) via the mobile terminal 3, the authentication control unit 114 performs a login to the casino service providing apparatus 2. On the other hand, for example, in a case where the user 11 inputs invalid authentication information via the mobile terminal 3, the authentication control unit 114 does not perform a login to the casino service providing apparatus 2.

In a case where each user 11 makes an exit request from the casino facility 20 at the entry and exit gate GT, the exit control unit 115 permits the exit of the user 11 who has made the exit request. Then, in a case where the exit of the user 11 is permitted, the exit control unit 115 stores information indicating that the exit of the user 11 is permitted as at least a part of the entry and exit information 133 in the information storage area 130, for example.

The use prohibition control unit 116 executes control to disable the use of the casino service using the mobile terminal 3 by the user 11 who has exited the casino facility 20. Specifically, even in a case where the user 11 who has exited inputs valid authentication information via the mobile terminal 3, the use prohibition control unit 116 sets a state in which the user 11 may not login to the casino service providing apparatus 2.

For example, the information transmission control unit 117 permits transmission of various information to the mobile terminal 3 used by the user 11 who has entered the casino facility 20. Specifically, for example, the information transmission control unit 117 permits transmission of various information from the casino service providing apparatus 2 to the mobile terminal 3 used by the user 11.

In addition, for example, the information transmission control unit 117 prohibits transmission of various kinds of information to the mobile terminal 3 used by the user 11 who has exited from the casino facility 20. Specifically, for example, the information transmission control unit 117 prohibits transmission of various information from the casino service providing apparatus 2 to the mobile terminal 3 used by the user 11.

In a case where the exit control unit 115 permits the exit of the user 11, the information output unit 118 transmits various kinds of information to an output apparatus (not illustrated) such as a monitor adjacent to the entry and exit gate GT, for example. In this case, the output apparatus displays various kinds of information transmitted from the information output unit 118 so that the user 11 who has exited from the entry and exit gate GT views. The terminal rental information 134, the account information 135, and the deposit and withdrawal history information 136 will be described later.

### Outline of First Embodiment

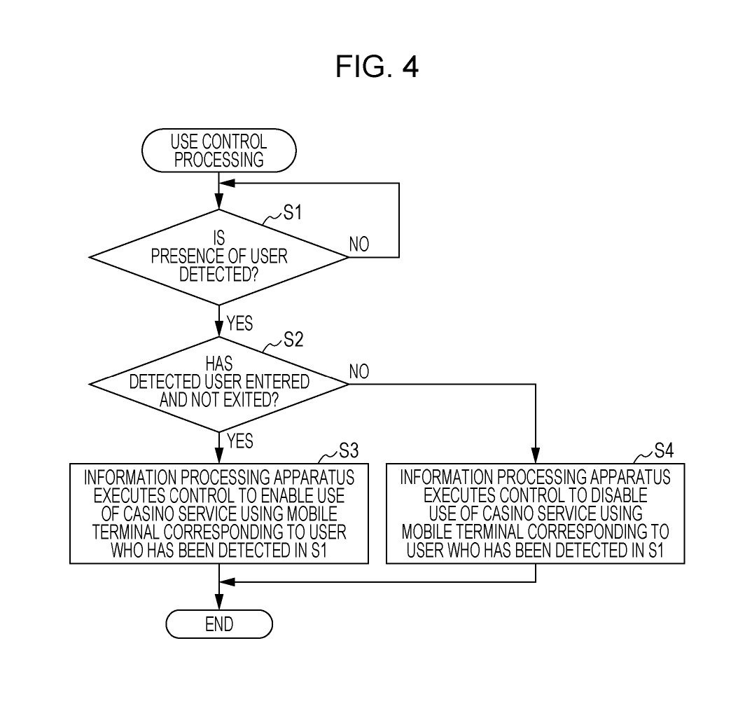

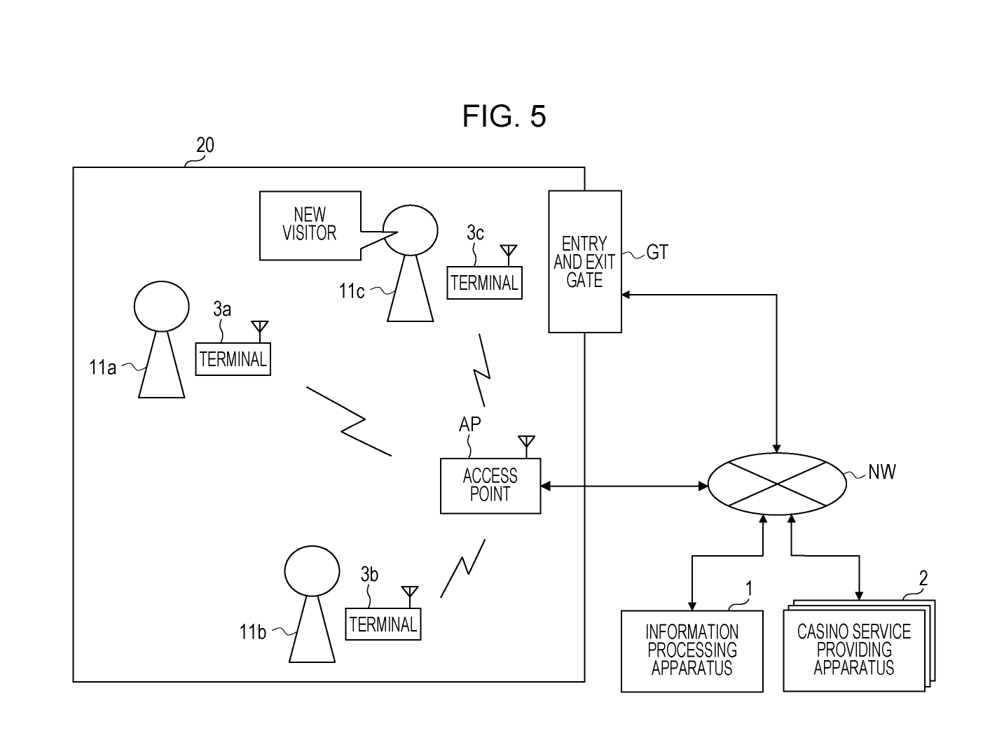

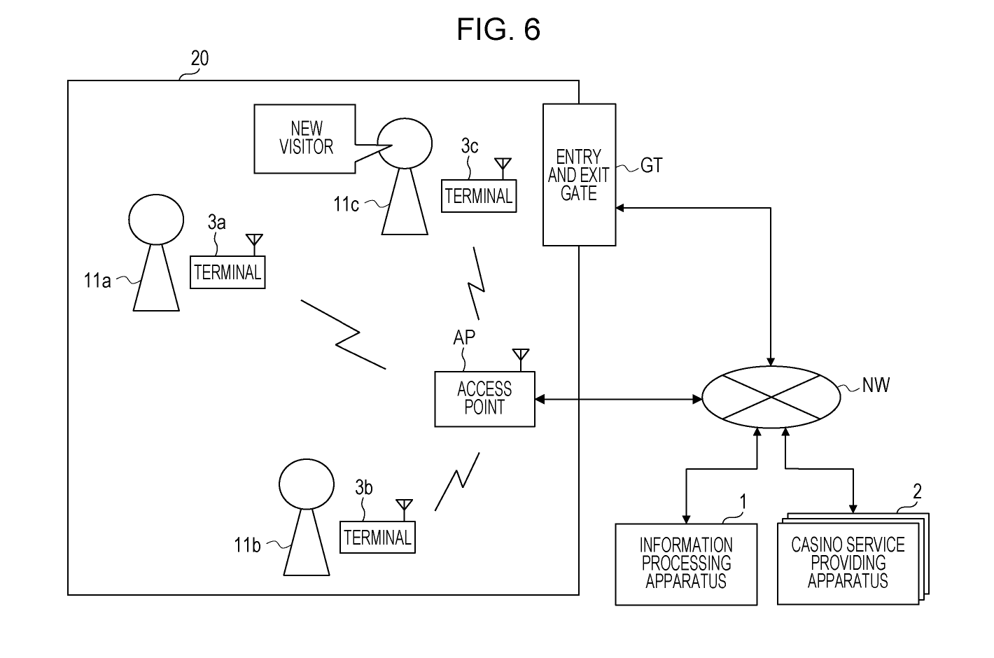

Next, the outline of the first embodiment will be described. FIG. 4 is a flowchart illustrating an outline of use control processing in a first embodiment. In addition, FIGS. 5 and 6 are diagrams illustrating an outline of use control processing in the first embodiment. With reference to FIGS. 5 and 6, the outline of the use control processing illustrated in FIG. 4 will be described.

As illustrated in FIG. 4, the information processing apparatus 1 stands by until the presence of the user 11 is detected (NO in S1).

In a case where the presence of the user 11 is detected (YES in S1), the information processing apparatus 1 determines whether or not the user 11 whose presence has been detected in the processing of S1 has entered and not yet exit (S2).

Specifically, as illustrated in FIG. 5, in a case where the entry of a user 11c (hereinafter, also referred to as visitor) in the entry and exit gate GT is detected, the information processing apparatus 1 determines whether or not the user 11c has entered and not yet exit, for example.

As a result, in a case where it is determined that the user 11 whose presence has been detected in the processing of S1 has entered and not yet exit (YES in S2), the information processing apparatus 1 executes control to enable use of the casino service using the mobile terminal 3 corresponding to the user 11 whose presence has been detected in the processing of S1 (S3).

Specifically, as illustrated in FIG. 6, in a case where it is determined that the user 11c has entered and not yet exit, the information processing apparatus 1 determines that the user 11c is staying in the casino facility 20 and enables use of the casino service from the mobile terminal 3c.

That is, among the users 11 who have already entered the casino facility 20, for the user 11 who has already exit from the casino facility, it is demanded to prohibit the use of the casino service until entering the casino facility 20 again. Therefore, in a case where it is determined that the user 11 whose presence has been detected in the processing of S1 has entered and not yet exit, the information processing apparatus 1 executes control to enable use of the casino service using the mobile terminal 3.

In this way, the information processing apparatus 1 may stop the casino service from being used from outside the casino facility 20 by the user 11 that has already entered and exit the casino facility 20.

On the other hand, in a case where it is not determined that the user 11 whose presence has been detected in the processing of S1 has entered and not yet exit (NO in S2), the information processing apparatus 1 executes control to disable use of the casino service using the mobile terminal 3 corresponding to the user 11 whose presence has been detected in the processing of S1 (S4).

Specifically, for example, in a case where it is not determined that the user 11c has entered and not yet exit, the information processing apparatus 1 determines that the user 11c is not staying in the casino facility 20 and disables use of the casino service from the mobile terminal 3c.

In this way, even in the case where the casino service using the mobile terminal 3 is provided at the casino facility 20, the information processing apparatus 1 may avoid occurrence of situations in which it is possible to use the casino service from outside the casino facility 20.

### Details of First Embodiment

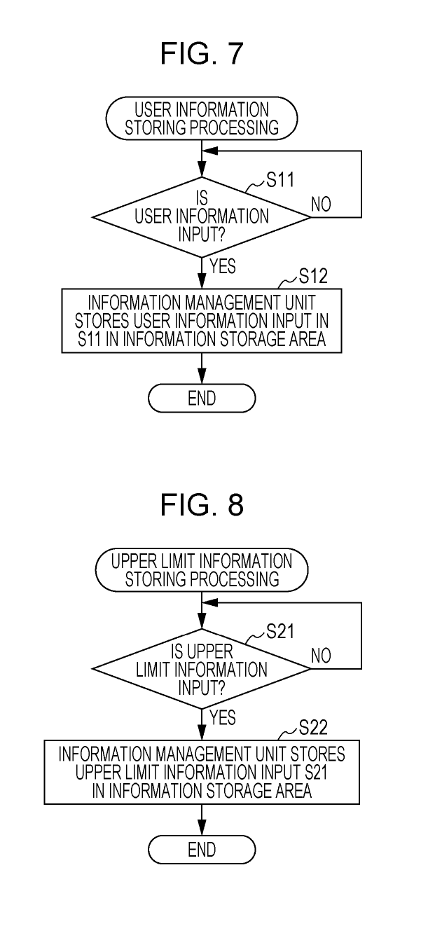

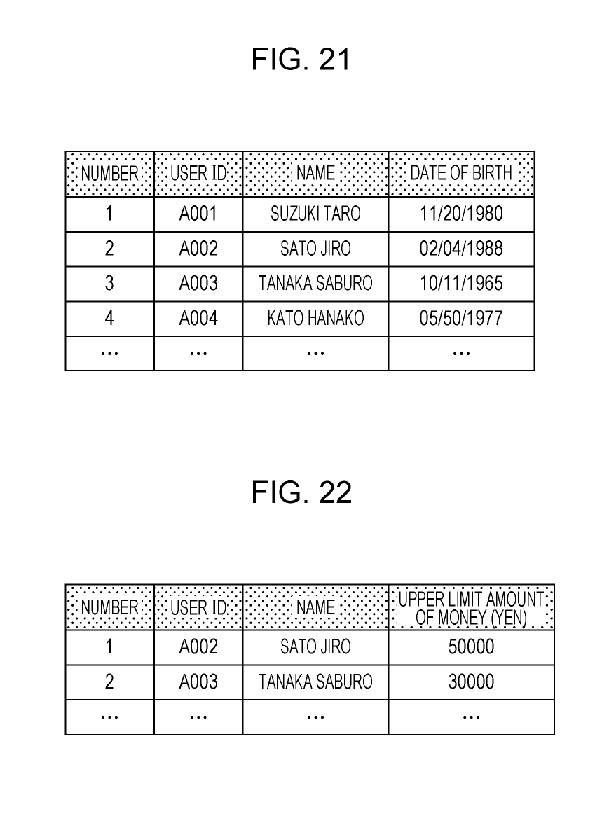

Next, the details of the first embodiment will be described. FIGS. 7 to 20 are flowcharts illustrating the details of use control processing in the first embodiment. In addition, FIGS. 21 to 26 are diagrams illustrating the details of use control processing in the first embodiment. The use control processing illustrated in FIGS. 7 to 20 will be described in detail with reference to FIGS. 21 to 26.

User Information Storing Processing

First, a specific example of the processing of storing the user information 131 (hereinafter, also referred to as user information storing processing) in the use control processing will be described. FIG. 7 is a flowchart illustrating user information storing processing.

As illustrated in FIG. 7, the information management unit 111 of the information processing apparatus 1 waits until the user information 131 is input (NO in S11). Specifically, for example, the information management unit 111 stands by until the user 11 who wants to use the casino service at the casino facility 20 inputs the user information 131 from the input terminal (not illustrated) arranged outside the entry and exit gate GT.

In a case where the user information 131 is input (YES in S11), the information management unit 111 stores the user information 131 input in the processing of S11 in the information storage area 130 (S12). A specific example of the user information 131 will be described below.

Specific Example of User Information

FIG. 21 is a diagram illustrating a specific example of user information 131.

The user information 131 illustrated in FIG. 21 has “NUMBER” for identifying each information included in the user information 131, “USER ID” for identifying each user 11, “NAME” where the name of each user 11 is set, and “DATE OF BIRTH” where the birth date of each user 11 is set, as items.

Specifically, in the user information 131 illustrated in FIG. 21, “A001” is set as “USER ID”, “SUZUKI TARO” is set as “NAME”, and “11/20/1980” is set as “DATE OF BIRTH” in the information whose “NUMBER” is “1”.

In addition, in the user information 131 illustrated in FIG. 21, “A002” is set as “USER ID”, “SATO JIRO” is set as “NAME”, and “02/04/1988” is set as “DATE OF BIRTH” in the information whose “NUMBER” is “2”. Description of other information included in FIG. 21 will be omitted.

Upper Limit Information Storing Processing

Next, a specific example of the processing of storing the upper limit information 132 (hereinafter, also referred to as upper limit information storing processing) in the use control processing will be described. FIG. 8 is a flowchart illustrating upper limit information storing processing.

As illustrated in FIG. 8, the information management unit 111 stands by until the upper limit information 132 is input (NO in S21). Specifically, for example, the information management unit 111 stands by until a person in charge of the casino facility 20 who has received a contact from the relative of the user 11 who wants to use the casino service inputs the upper limit information 132 to the information processing apparatus 1.

Then, in a case where the upper limit information 132 is input (YES in S21), the information management unit 111 stores the upper limit information 132 input in the processing of S21 in the information storage area 130 (S22). Hereinafter, a specific example of the upper limit information 132 will be described.

Specific Example of Upper Limit Information

FIG. 22 is a diagram illustrating a specific example of upper limit information 132.

The upper limit information 132 illustrated in FIG. 22 has “NUMBER” for identifying each information included in the upper limit information 132, “USER ID” for identifying each user 11, “NAME” where the name of each user 11 is set, “UPPER LIMIT AMOUNT OF MONEY” to which the upper limit of the amount that each user 11 may use when using the casino service is set, as items.

Specifically, in the upper limit information 132 illustrated in FIG. 22, “A002” is set as “USER ID”, “SATO JIRO” is set as “NAME”, and “50000 (YEN)” is set as “UPPER LIMIT AMOUNT OF MONEY” in the information whose “NUMBER” is “1”.

In addition, in the upper limit information 132 illustrated in FIG. 22, “A003” is set as “USER ID”, “TANAKA SABURO” is set as “NAME”, and “30000 (YEN)” is set as “UPPER LIMIT AMOUNT OF MONEY” in the information whose “NUMBER” is “2”. Description of other information included in FIG. 22 will be omitted.

Entry Control Processing

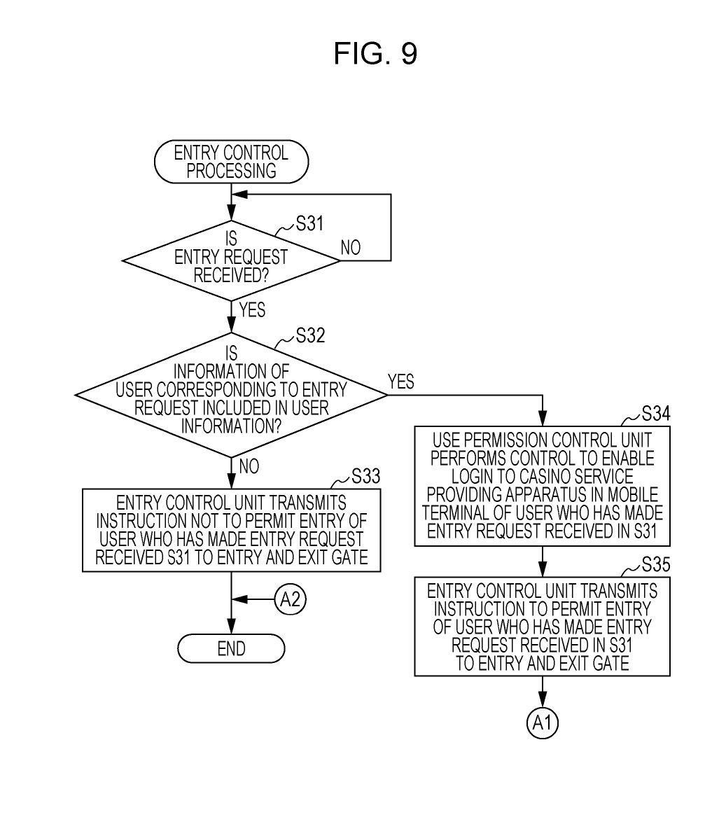

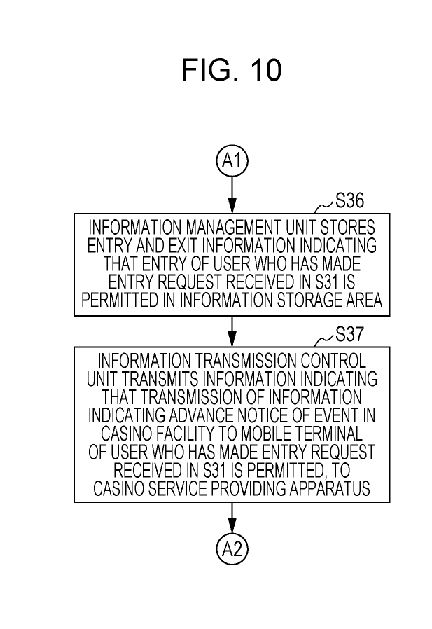

Next, a specific example of the processing of controlling the entry of the user 11 (hereinafter, also referred to as entry control processing) in the use control processing will be described. FIGS. 9 and 10 are flowcharts illustrating entry control processing.

As illustrated in FIG. 9, the entry control unit 112 of the information processing apparatus 1 waits until receiving an entry request (NO in S31). Specifically, the entry control unit 112 stands by until a new user 11 attempts to enter the casino facility 20 at the entry and exit gate GT.

Then, in a case where an entry request is received (YES in S31), the entry control unit 112 refers to the user information 131 stored in the information storage area 130 and determines whether or not information for identifying the user 11 who made an entry request is included (S32).

As a result, in a case where it is determined that the information for identifying the user 11 who has made the entry request is not included (NO in S32), the entry control unit 112 transmits an instruction not to permit the entry of the user 11 who has made the entry request received in the processing of S31, to the entry and exit gate GT (S33).

In this way, the information processing apparatus 1 may prohibit entry of the user 11 who is not be allowed to enter the casino facility 20.

On the other hand, in a case where it is determined that the information for identifying the user 11 who has made the entry request is included (YES in S32), the use permission control unit 113 of the information processing apparatus 1 performs control to enable login to the casino service providing apparatus 2 in the mobile terminal 3 of the user 11 who has made the entry request received in the processing of S31 (S34).

Then, the entry control unit 112 transmits an instruction to permit entry of the user 11 who made the entry request received in the processing of S31 to the entry and exit gate GT (S35).

Subsequently, as illustrated in FIG. 10, the information management unit 111 stores the entry and exit information 133 indicating that the entry of the user 11 who made the entry request received in the processing of S31 is permitted, in the information storage area 130 (S36). A specific example of the entry and exit information 133 will be described below.

Specific Example of Entry and Exit Information

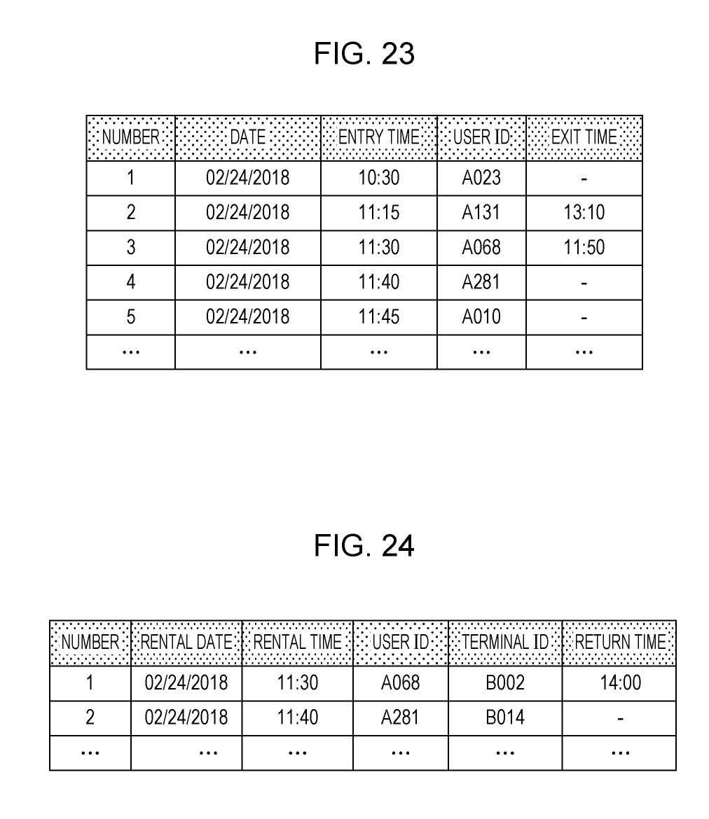

FIG. 23 is a diagram illustrating a specific example of entry and exit information 133.

The entry and exit information 133 illustrated in FIG. 23 has “NUMBER” for identifying each piece of information included in the entry and exit information 133, “DATE” in which the date of entry of each user 11 is set, and “ENTRY TIME” at which each user 11 has entered the casino facility 20 is set, as items. In addition, the entry and exit information 133 illustrated in FIG. 23 has “USER ID” for identifying each user 11 who has entered the casino facility 20 and “EXIT TIME” at which each user 11 has exited the casino facility 20 is set, as items. At “EXIT TIME”, time at which each user 11 has exited the casino facility 20 or “-” indicating that each user 11 has not yet exit from the casino facility 20 is set.

Specifically, in the entry and exit information 133 illustrated in FIG. 23, “02/24/2018” is set as “DATE”, “10:30” is set as “ENTRY TIME”, “A023” is set “USER ID”, and “-” is set as “EXIT TIME” in the information whose “NUMBER” is “1”.

In addition, in the entry and exit information 133 illustrated in FIG. 23, “02/24/2018” is set as “DATE”, “11:15” is set as “ENTRY TIME”, “A131” is set as “USER ID”, and “13:10” is set as “EXIT TIME” in the information whose “NUMBER” is “2”. Description of other information included in FIG. 23 will be omitted.

Returning to FIG. 10, for example, the information transmission control unit 117 of the information processing apparatus 1 transmits information to permit transmission of at least one of pieces of information indicating an advance notice of an event in the casino facility 20 and information indicating an event occurring within the casino facility 20 to the mobile terminal 3 of the user 11 who has made the entry request received in the processing of S31, to the casino service providing apparatus 2 (S37).

In this way, the information processing apparatus 1 may start transmission of useful information to the user 11 who has been permitted to enter the casino facility 20.

Rental Management Processing

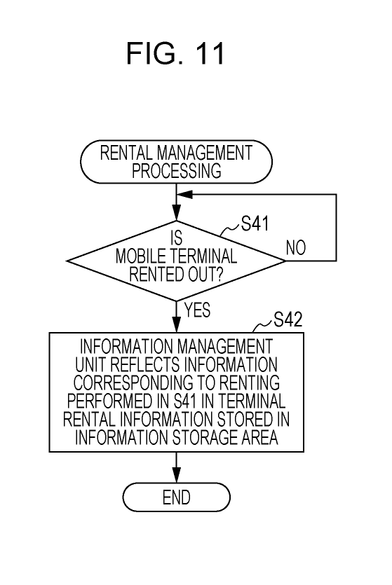

Next, a specific example of the processing of managing rental of the mobile terminal 3 (hereinafter, also referred to as rental management processing) in the use control processing will be described. FIG. 11 is a flowchart illustrating rental management processing.

As illustrated in FIG. 11, the information management unit 111 stands by until the mobile terminal 3 is rented out within the casino facility 20 (NO in S41).

That is, there is a possibility that the users 11 who wants to use the casino service includes the user 11 not possessing his or her mobile terminal 3 or the user 11 who does not want to use the casino service using his or her own mobile terminal 3. Therefore, at the casino facility 20, for example, the mobile terminal 3 for using the casino service may be rented out.

Then, in a case where the mobile terminal 3 is rented out (YES in S41), the information management unit 111 reflects the information corresponding to the renting performed in the processing of S41 in the terminal rental information 134 stored in the information storage area 130 (S42). A specific example of the terminal rental information 134 will be described below.

Specific Example of Terminal Rental Information

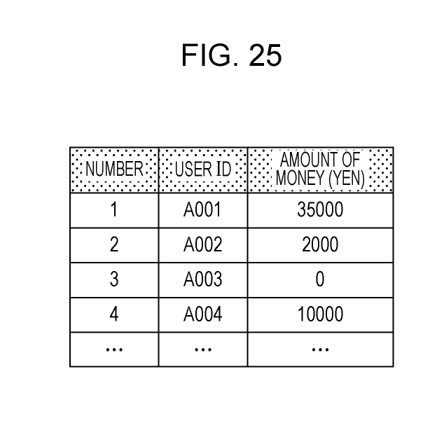

FIG. 24 is a diagram illustrating a specific example of terminal rental information 134.

The terminal rental information 134 illustrated in FIG. 24 has “NUMBER” for identifying each information included in the terminal rental information 134, “RENTAL DATE” in which the date of renting of each mobile terminal 3 is set, and “RENTAL TIME” in which the time of renting of each mobile terminal 3 is set, as items. In addition, the terminal rental information 134 illustrated in FIG. 24 has “USER ID” for identifying the user 11 who has rent out each mobile terminal 3, “TERMINAL ID” for identifying each mobile terminal 3, and “RETURN TIME” in which the time at which each mobile terminal 3 is returned is set, as items. In “RETURN TIME”, time at which each mobile terminal 3 is returned or “-” indicating that each mobile terminal 3 has not yet been returned is set.

Specifically, in the terminal rental information 134 illustrated in FIG. 24, “02/24/2018” is set as “RENTAL DATE”, “11: 30” is set as “RENTAL TIME”, “A068” is set as “USER ID”, “B002” is set as “TERMINAL ID”, and “14:00” is set as the “RETURN TIME” in the information whose “NUMBER” is “1”.

In addition, in the terminal rental information 134 illustrated in FIG. 23, “02/24/2018” is set as the “RENTAL DATE”, “11: 40” is set as “RENTAL TIME”, “A281” is set as “USER ID”, “B014” is set as “TERMINAL ID”, and “-” is set as “RETURN TIME” in the information whose “NUMBER” is “2”. Description of other information included in FIG. 24 will be omitted.

Deposit Management Processing

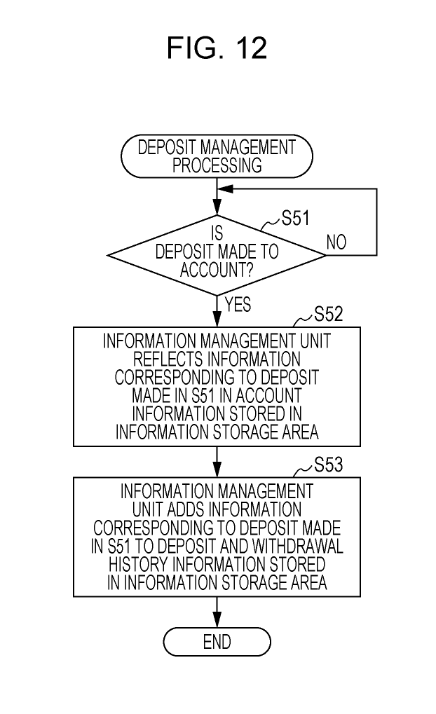

Next, a specific example of the processing of managing the deposit to the account of the user 11 (hereinafter, also referred to as deposit management processing) in the use control processing will be described. FIG. 12 is a flowchart illustrating deposit management processing.

As illustrated in FIG. 12, the information management unit 111 stands by until a deposit is made to the account of the user 11 (NO in S51). Specifically, for example, the information management unit 111 stands by until the user 11 deposits the cash to be used when using the casino service in a deposit apparatus (not illustrated) provided in the casino facility 20. In addition, for example, the information management unit 111 stands by until money to be returned by the use of the casino service by the user 11 is deposited to the account of the user 11 from the casino service providing apparatus 2.

Then, in a case where a deposit is made to the account of the user 11 (YES in S51), the information management unit 111 reflects the information corresponding to the deposit made in the processing of S51 in the account information 135 stored in the information storage area 130 (S52). A specific example of the account information 135 will be described below.

Specific Example of Account Information

FIG. 25 is a diagram illustrating a specific example of the account information 135.

The account information 135 illustrated in FIG. 25 has “NUMBER” for identifying each information included in the account information 135, “USER ID” for identifying each user 11, and “AMOUNT OF MONEY” indicating the amount of money that each user 11 may use when using the casino service, as items.

Specifically, in the account information 135 illustrated in FIG. 25, “A001” is set as the “USER ID” and “35000 (YEN)” is set as the “AMOUNT OF MONEY” in the information whose “NUMBER” is “1”.

In addition, in the account information 135 illustrated in FIG. 25, “A002” is set as “USER ID” and “2000 (YEN)” is set as “AMOUNT OF MONEY” in the information whose “NUMBER” is “2”. Description of other information included in FIG. 25 will be omitted.

Returning to FIG. 12, the information management unit 111 adds information corresponding to the deposit made in the processing of S51 to the deposit and withdrawal history information 136 stored in the information storage area 130 (S53). A specific example of the deposit and withdrawal history information 136 will be described below.

Specific Example of Deposit and Withdrawal History Information

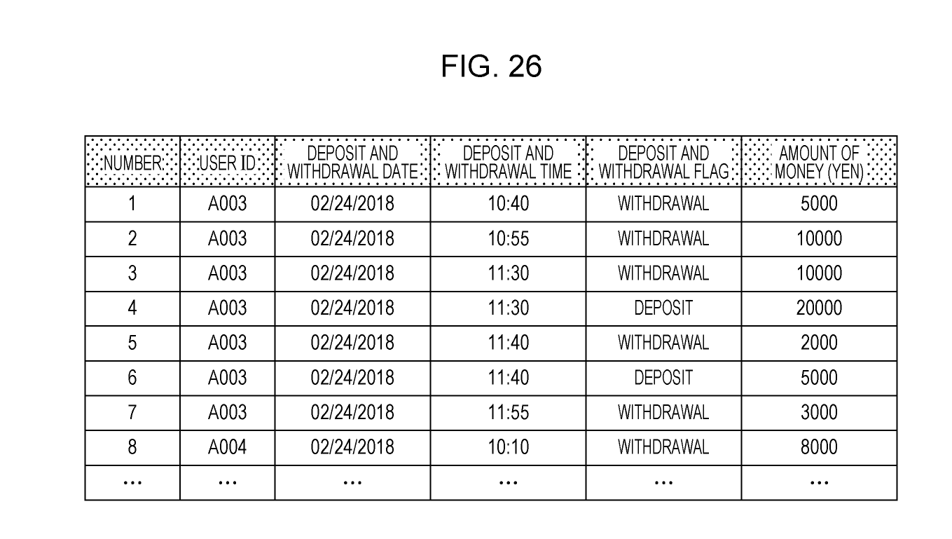

FIG. 26 is a diagram illustrating a specific example of deposit and withdrawal history information 136.

The deposit and withdrawal history information 136 illustrated in FIG. 26 has “NUMBER” for identifying each information included in the deposit and withdrawal history information 136, “USER ID” for identifying each user 11, and “DEPOSIT AND WITHDRAWAL DATE” in which the date (the date on which each user 11 has used the casino service) of deposit and withdrawal is set in the account of the user 11, as items. In addition, the deposit and withdrawal history information 136 illustrated in FIG. 26 has “DEPOSIT AND WITHDRAWAL TIME” in which the time (the time when each user 11 has used the casino service) at which a deposit or withdrawal is made in the account of the user 11 is set, “DEPOSIT AND WITHDRAWAL FLAG” for identifying which of deposit or withdrawal is made, and “AMOUNT OF MONEY (YEN)” in which the deposit amount or withdrawal amount made by each user 11 is set, as items. In “DEPOSIT AND WITHDRAWAL FLAG”, “DEPOSIT” indicating that a deposit has been made or “WITHDRAWAL” indicating that a withdrawal has been made are set.

Specifically, in the deposit and withdrawal history information 136 illustrated in FIG. 26, “A003” is set as “USER ID”, “02/24/2018” is set as “DEPOSIT AND WITHDRAW DATE”, “10:40” is set as “DEPOSIT AND WITHDRAWAL TIME”, “WITHDRAWAL” is set as “DEPOSIT and WITHDRAWAL FLAG”, and “5000 (YEN)” is set as “AMOUNT OF MONEY” in the information whose “NUMBER” is “1”.

In addition, in the deposit and withdrawal history information 136 illustrated in FIG. 26, “A003” is set as “USER ID”, “02/24/2018” is set as “DEPOSIT AND WITHDRAW DATE”, “11:30” is set as “DEPOSIT AND WITHDRAWAL TIME”, “DEPOSIT” is set as “DEPOSIT and WITHDRAWAL FLAG”, and “20000 (YEN)” is set as “AMOUNT OF MONEY” in the information whose “NUMBER” is “4”.

That is, in the deposit and withdrawal history information 136 illustrated in FIG. 26, the information in which “WITHDRAWAL” is set as “DEPOSIT AND WITHDRAWAL FLAG” is information generated in response to the withdrawal of the premium when the user 11 uses the casino game. In addition, in the deposit and withdrawal history information 136 illustrated in FIG. 26, the information in which “DEPOSIT” is set as “DEPOSIT AND WITHDRAWAL FLAG is information generated in response to the deposit of the money to be returned when the user 11 uses the casino game.

Login Processing

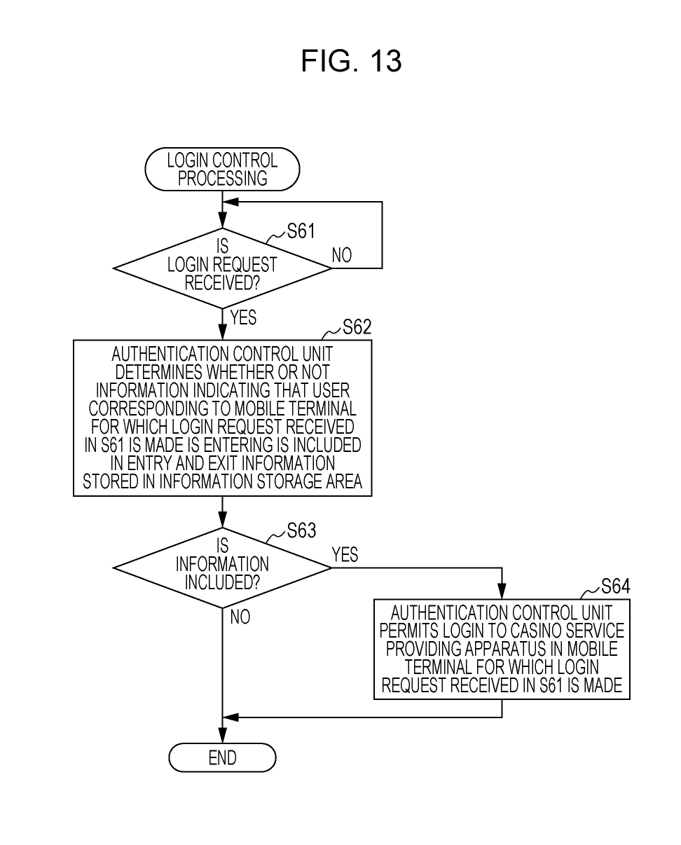

Next, a specific example of processing (hereinafter, login processing) in which the user 11 logs in to the casino service providing apparatus 2 in the use control processing will be described. FIG. 13 is a flowchart illustrating login processing.

As illustrated in FIG. 13, the authentication control unit 114 of the information processing apparatus 1 stands by until receiving a login request to the casino service providing apparatus 2 (NO in S61). Specifically, for example, the authentication control unit 114 stands by until receiving a login request to the casino service providing apparatus 2 that the user 11 makes on the mobile terminal 3.

Then, in a case where a login request is received (YES in S61), the authentication control unit 114 determines whether or not information indicating that the user 11 corresponding to the mobile terminal 3 on which the login request received in the processing of S 61 is made is entering the casino facility 20, is included in the entry and exit information 133 stored in the information storage area 130 (S62).

Specifically, for example, the authentication control unit 114 refers to the entry and exit information 133 stored in the information storage area 130 and confirms that the number of pieces of information indicating that the user 11 corresponding to the mobile terminal 3 on which the login request received in the processing of S61 is made has entered the casino facility 20 is one more than the number of pieces of information indicating that the user 11 has exited from the casino facility 20.

As a result, in a case where it is determined that information indicating that the user 11 is entering the casino facility 20 is included (YES in S63), the authentication control unit 114 permits a login to the casino service providing apparatus 2 in the mobile terminal 3 on which the login request received in the processing of S61 is made (S64).

On the other hand, in a case where it is determined that the information indicating that the user 11 is entering the casino facility 20 is not included (NO in S63), the authentication control unit 114 does not perform the processing in S 64.

That is, the information processing apparatus 1 permits a login to the casino service providing apparatus 2 via the mobile terminal 3 only in a case where the user 11 is entering the casino facility 20.

In this way, the information processing apparatus 1 may avoid occurrence of situations in which the casino service may be provided from outside the casino facility 20.

Withdrawal Management Processing

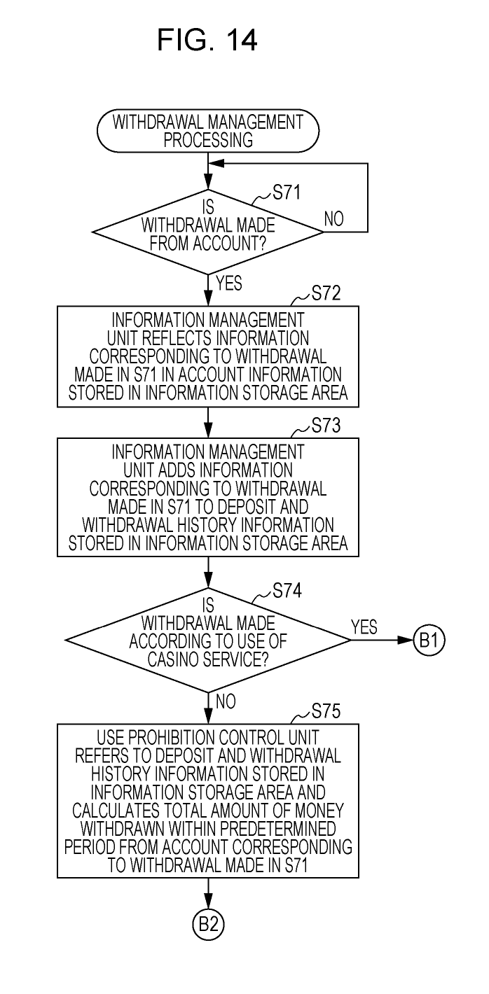

Next, a specific example of the processing of managing withdrawal from the account of the user 11 (hereinafter, also referred to as withdrawal management processing) in the use control processing will be described. FIG. 14 is a flowchart illustrating withdrawal management processing.

As illustrated in FIG. 14, the information management unit 111 stands by until a withdrawal is made from the account of the user 11 (NO in S71). Specifically, for example, the information management unit 111 stands by until a withdrawal is made by the user 11 in a settlement apparatus (not illustrated) provided in the casino facility 20. In addition, for example, the information management unit 111 stands by until a withdrawal of a premium by the casino service providing apparatus 2 in accordance with use of the casino service is made by the user 11.

Then, in a case where a withdrawal is made from the account of the user 11 (YES in S71), the information management unit 111 reflects the information corresponding to the withdrawal made in the processing of S71 in the account information 135 stored in the information storage area 130 (S72).

Thereafter, the information management unit 111 adds information corresponding to the withdrawal made in the processing of S71 to the deposit and withdrawal history information 136 stored in the information storage area 130 (S73).

Subsequently, the information management unit 111 determines whether or not the withdrawal made in the processing of S71 has been performed in accordance with the use of the casino service by the user 11 (S74).

As a result, in a case where it is determined that the withdrawal is performed in accordance with the use of the casino service by the user 11 (YES in S74), the use prohibition control unit 116 of the information processing apparatus 1 refers to the deposit and withdrawal history information 136 stored in the information storage area 130 and calculates the total amount of money withdrawn within a predetermined period from the account corresponding to the withdrawal made in the processing of S71 (S75). The predetermined period of time is, for example, the time from the time the casino facility 20 opens to present time.

Specifically, in the example illustrated in FIG. 26, “5000 (YEN)”, “10000 (YEN)”, “10000 (YEN)”, “2000 (YEN)” and “3000 (YEN)” are respectively set in “AMOUNT OF MONEY” of information (information whose “NUMBER” is “1”, “2”, “3”, “5”, and “7”) whose “USER ID” is “A003” and “DEPOSIT AND WITHDRAWAL FLAG” is “WITHDRAWAL”. Therefore, in this case, the use prohibition control unit 116 calculates “30000 (YEN)” as the total amount of money withdrawn within the predetermined period.

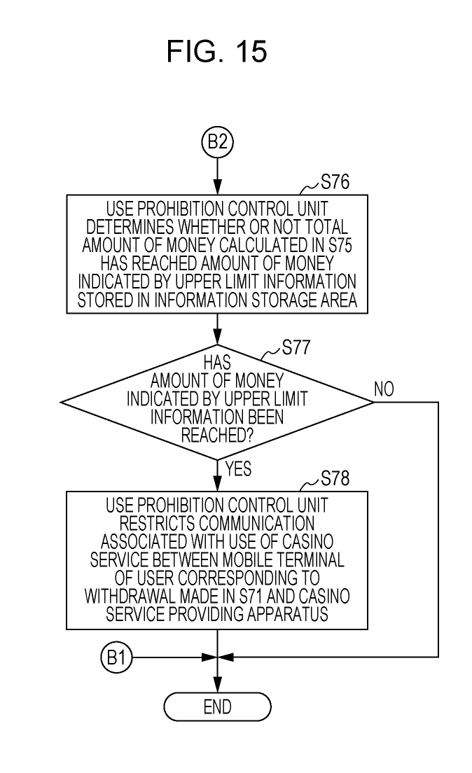

Subsequently, as illustrated in FIG. 15, the use prohibition control unit 116 determines whether or not the total amount of money calculated in the processing of S 75 has reached the amount of money indicated by the upper limit information 132 stored in the information storage area 130 (S76).

As a result, in a case where it is determined that the amount of money indicated by the upper limit information 132 has been reached (YES in S77), the use prohibition control unit 116 restricts communication associated with use of the casino service between the mobile terminal 3 of the user 11 corresponding to the withdrawal made in the processing of S71 (S78) and the casino service providing apparatus 2.

Specifically, in the example illustrated in FIG. 22, “30000 (YEN)” is set as the “UPPER LIMIT AMOUNT OF MONEY” of information whose “USER ID” is “A003” (information whose “NUMBER” is “2”). For that reason, in this case, the information management unit 111 determines that “30000 (YEN)” which is the total amount of money calculated in the processing of S75 has reached the amount of money indicated by the upper limit information 132 stored in the information storage area 130 and prohibits communication associated with use of the casino service between the mobile terminal 3 and the casino service providing apparatus 2, for example.

In this way, the information processing apparatus 1 may limit excessive use of the casino service by the user 11.

On the other hand, in a case where it is determined that the amount of money indicated by the upper limit information 132 has not been reached (NO in S77), the use prohibition control unit 116 does not perform the processing of S78.

The information management unit 111 may calculate an amount of money (hereinafter also referred to as total damage amount of money) obtained by subtracting the total amount of money deposited within a predetermined period from the total amount of money withdrawn within a predetermined period in the processing of S75. Then, the information management unit 111 may determine whether or not the total damage amount of money has reached the amount of money indicated by the upper limit information 132 in the processing of S76.

Logout Processing

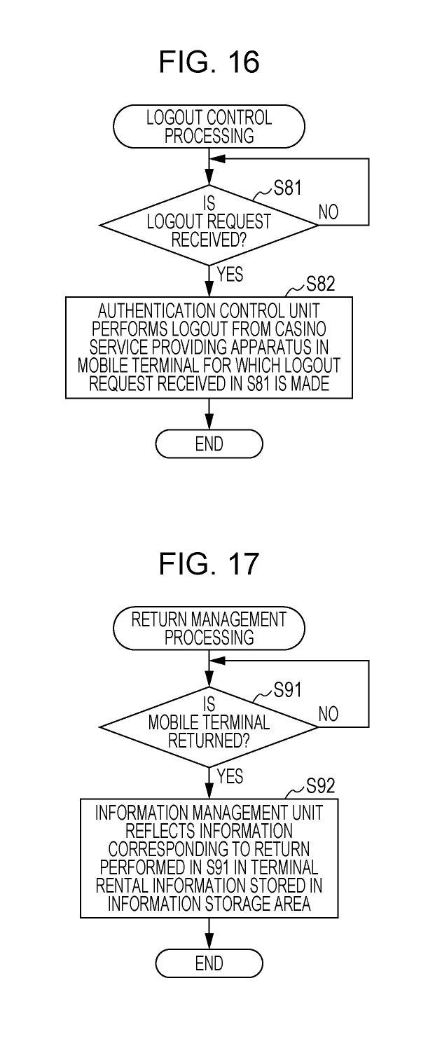

Next, a specific example of processing (hereafter, referred to as logout processing) in which the user 11 logs out from the casino service providing apparatus 2 in the use control processing will be described. FIG. 16 is a flowchart illustrating logout processing.

As illustrated in FIG. 16, the authentication control unit 114 stands by until receiving a logout request from the casino service providing apparatus 2 (NO in S81). Specifically, the authentication control unit 114 stands by until receiving a logout request from the casino service providing apparatus 2 that the user 11 has made via the mobile terminal 3.

Then, in a case where a logout request is received (YES in S81), the authentication control unit 114 performs a logout from the casino service providing apparatus 2 in the mobile terminal 3 on which the logout request received in the processing of S81 is made (S82).

Return Management Processing

Next, a specific example of the processing of managing return of the mobile terminal 3 (hereinafter, also referred to as return management processing) in the use control processing will be described. FIG. 17 is a flowchart illustrating return management processing.

As illustrated in FIG. 17, the information management unit 111 stands by until the mobile terminal 3 is returned within the casino facility 20 (NO in S91).

Then, in a case where the mobile terminal 3 is returned (YES in S91), the information management unit 111 reflects the information corresponding to the return performed in the processing of S91 in the terminal rental information 134 stored in the information storage area 130 (S92).

Exit Control Processing

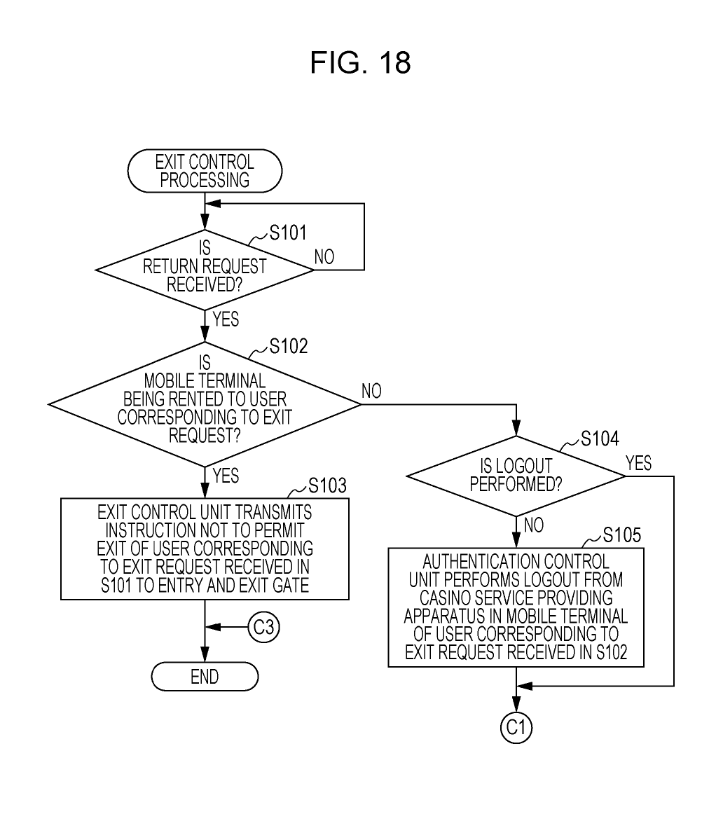

Next, a specific example of the processing of controlling the exit of the user 11 (hereinafter, also referred to as exit control processing) in the use control processing will be described. FIGS. 18 to 20 are flowcharts illustrating exit control processing.

As illustrated in FIG. 18, the exit control unit 115 of the information processing apparatus 1 stands by until an exit request is received (NO in S101). Specifically, the exit control unit 115 stands by until the user 11 attempts to exit the casino facility 20 at the entry and exit gate GT.

Then, in a case where an exit request is received (YES in S101), the exit control unit 115 refers to the terminal rental information 134 stored in the information storage area 130 and determines whether or not the mobile terminal 3 is being rented to the user 11 who has made the exit request (S102).

As a result, in a case where it is determined that the mobile terminal 3 is being rented to the user 11 who has made the exit request (YES in S102), the exit control unit 115 transmits an instruction not to permit the exit of the user 11 corresponding to the exit request received in the processing of S101 to the entry and exit gate GT (S103).

Then, in this case, for example, the exit control unit 115 displays information for prompting the user 11 who has made the exit request to return the mobile terminal 3 being rented on an output apparatus (not illustrated) adjacent to the entry and exit gate GT.

On the other hand, in a case where it is determined that the mobile terminal 3 is not being rented to the user 11 who has made the exit request (NO in S102), the authentication control unit 114 determines whether or not a logout is performed from the casino service providing apparatus 2 in the mobile terminal 3 of the user 11 corresponding to the exit request received in the processing of S101 (S104).

As a result, in a case where it is determined that a logout from the casino service providing apparatus 2 is not performed (NO in S104), the authentication control unit 114 performs a logout from the casino service providing apparatus 2 in the mobile terminal 3 of the user 11 corresponding to the exit request received in the processing of S102 (S105).

In this way, the information processing apparatus 1 may avoid occurrence of situations in which the casino service may be provided from outside the casino facility 20.

On the other hand, in a case where it is determined that logout from the casino service providing apparatus 2 is being performed (YES in S104), the authentication control unit 114 does not perform the processing of S105.

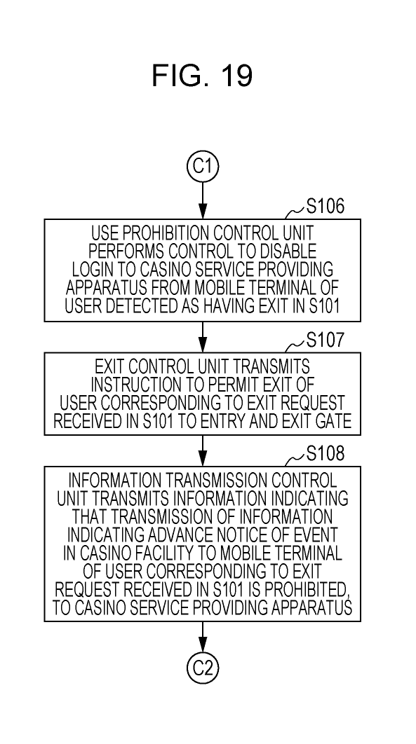

Subsequently, as illustrated in FIG. 19, the use prohibition control unit 116 performs control to disable the login to the casino service providing apparatus 2 from the mobile terminal 3 of the user 11 whose exit has been detected in the processing of S101 (S106).

In addition, the exit control unit 115 transmits an instruction to permit exit of the user 11 corresponding to the exit request received in the processing of S101, to the entry and exit gate GT (S107).

Then, for example, the information transmission control unit 117 transmits information to prohibit transmission of at least one of pieces of information indicating an advance notice of an event in the casino facility 20 and information indicating an event occurring within the casino facility 20 to the mobile terminal 3 of the user 11 who has made the exit request received in the processing of S101, to the casino service providing apparatus 2 (S108).

Specifically, for example, among the information indicating the advance notice of event in the casino facility 20 and the information indicating the event occurring in the casino facility 20, the information transmission control unit 117 may transmit information to prohibit transmission of only the information indicating the event occurring within the casino facility 20 to the mobile terminal 3 of the user 11, to the casino service providing apparatus 2.

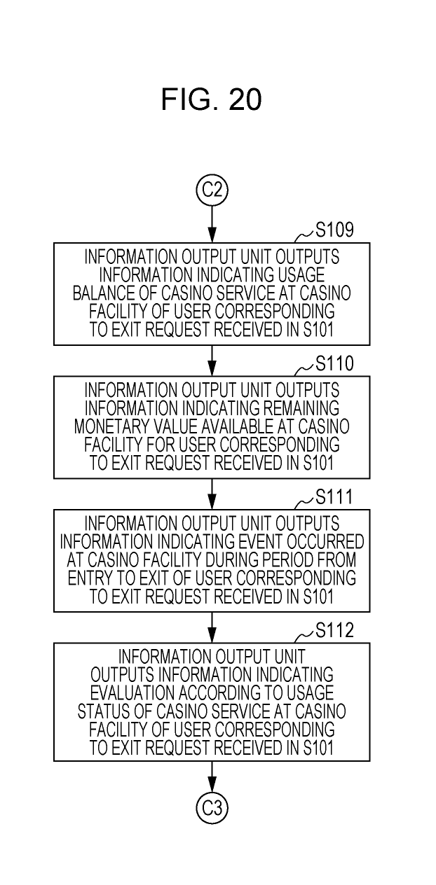

Thereafter, as illustrated in FIG. 20, for example, the information output unit 118 of the information processing apparatus 1 outputs information indicating the usage balance of the casino service in the casino facility 20 of the user 11 corresponding to the exit request received in the process of S101 (S109).

Specifically, for example, the information output unit 118 may refer to the deposit and withdrawal history information 136 stored in the information storage area 130 and outputs the total amount of the premium and the money to be returned between the entry of the user 11 and the exit, respectively.

In this case, for example, the information output unit 118 may output the information indicating the usage balance in each of the categories according to the types of gambling that may be played in the casino facility 20 and the information indicating the usage balance in each of the categories according to the areas in the casino facility 20.

In addition, the information output unit 118 outputs information indicating the remaining monetary value available in the casino facility 20 for the user 11 corresponding to the exit request received in the processing of S101 (S110).

Specifically, for example, the information output unit 118 may refer to the account information 135 stored in the information storage area 130 and output the amount of money currently deposited in the account of the user 11 or the number of chips corresponding to the amount currently deposited in the account of the user 11.

In addition, for example, the information output unit 118 outputs information indicating events occurred at the casino facility 20 during the period from the entry to the exit of the user 11 corresponding to the exit request received in the processing of S101 (S111).

Specifically, for example, the information output unit 118 may output the type of the casino game, the amount of money to be returned, and the like in which the money to be returned exceeding a predetermined threshold value has occurred within the casino facility 20.

Furthermore, for example, the information output unit 118 outputs information indicating the evaluation according to the usage status of the casino service at the casino facility 20 of the user 11 corresponding to the exit request received in the processing of S101 (S112).

Specifically, for example, the information output unit 118 may refer to the entry and exit information 133 and the deposit and withdrawal history information 136 stored in the information storage area 130 and output the evaluation of the user 11 according to the staying time in the casino facility 20, the total amount of the premium used for using the casino service, and the like.

For example, the evaluation of the user 11 may include information (information indicating a current rank of the user 11) indicating the content of the benefit granted to the user 11. In addition, the evaluation of the user 11 may include, for example, information (information indicating conditions for the user 11 to be promoted to a next rank) indicating a staying time or a premium for providing a further benefit to the user 11.

In this way, the information processing apparatus 1 may give the user 11 the motivation to come to the casino facility 20 again.

As described above, the information processing apparatus 1 according to the present embodiment executes control to enable use of the casino service using the mobile terminal 3 possessed by the user 11 whose entry has been detected in response to detection of entry of the user 11 into the casino facility 20. In addition, the information processing apparatus 1 executes control to disable use of the casino service using the mobile terminal 3 possessed by the user 11 whose exit has been detected in response to detection of exit of the user 11 from the casino facility 20.

That is, the information processing apparatus 1 enables use of the casino service via the mobile terminal 3 by the user 11, for example, only while the user 11 enters the casino facility 20 until exiting the casino facility 20.

In this way, even in the case where the casino service using the mobile terminal 3 is provided at the casino facility 20, the information processing apparatus 1 may avoid occurrence of situations in which it is possible to use the casino service from outside the casino facility 20.

Additional-Note_14. A method executed by a computer, includes: executing control to enable use of a facility service using a mobile terminal corresponding to a visitor in response to an entry detection signal of the visitor to a facility; and executing control to disable use of the facility service using the mobile terminal corresponding to the visitor in response to an exit detection signal of the visitor from the facility.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing therein a control program for causing a computer to execute a process, the process comprising:
executing control to enable use of a facility service using a mobile terminal corresponding to a visitor in response to an entry detection signal of the visitor from a facility; and
executing control to disable use of the facility service using the mobile terminal corresponding to the visitor in response to an exit detection signal of the visitor from the facility.

2. The non-transitory computer-readable recording medium storing therein a program according to claim 1,
wherein, in the process of executing control to enable use of the service in the facility, the processor controls to permit a login for the visitor to start use of the service in the facility, and
in the process of executing control to disable use of the service in the facility, the processor controls to prohibit the login.

3. The non-transitory computer-readable recording medium storing therein a program according to claim 1, the process further comprising:
outputting information indicating a staying time from entry to exit of the visitor in response to the exit detection signal.

4. The non-transitory computer-readable recording medium storing therein a program according to claim 1, the process further comprising:
outputting information indicating a usage balance of the service of the visitor in the facility in response to the exit detection signal.

5. The non-transitory computer-readable recording medium storing therein a program according to claim 4,
wherein the information indicating the usage balance is information indicating a usage balance in each of categories according to types of gambling that is capable of being played in the facility or information indicating a usage balance in each of categories corresponding to areas in the facility.

6. The non-transitory computer-readable recording medium storing therein a program according to claim 1, the process further comprising:
outputting information indicating a remaining monetary value available for the visitor in the facility in response to the exit detection signal.

7. The non-transitory computer-readable recording medium storing therein a program according to claim 1, the process further comprising:
outputting information indicating an event occurring in the facility between entry and exit of the visitor in response to the exit detection signal.

8. The non-transitory computer-readable recording medium storing therein a program according to claim 1, the process further comprising:
outputting information indicating an evaluation in accordance with a use situation of the service of the visitor in the facility in response to the exit detection signal.

9. A non-transitory computer-readable recording medium storing therein a program for causing a computer to execute a process, the process comprising:
receiving an entry detection signal of a visitor from a facility; and
in response to the entry detection signal of the visitor, executing control to permit transmission of information indicating an advance notice of an event in the facility or information indicating an event occurring in the facility after an entry is detected by the processor, to a mobile terminal corresponding to the visitor.

10. The non-transitory computer-readable recording medium storing therein a program for causing a computer to execute a process according to claim 9, the process further comprising:
in response to the exit detection signal of the visitor from the facility, executing control not to perform the transmission of the information indicating the advance notice of the event in the facility or the information indicating the event occurring in the facility after the entry is detected by the processor, to the mobile terminal corresponding to the visitor.

11. The non-transitory computer-readable recording medium storing therein a program for causing a computer to execute a process according to claim 9, the process further comprising:
in response to the exit detection signal of the visitor from the facility, executing control to permit the transmission of information indicating the advance notice of the event in the facility to the mobile terminal and not to perform the transmission of information indicating the event occurring in the facility after the entry is detected by the processor, to the mobile terminal.

12. A use control apparatus comprising:
a memory;
a processor coupled to the memory and the processor comprising:
executing control to enable use of a facility service using a mobile terminal corresponding to a visitor in response to an entry detection signal of the visitor to a facility; and
executing control to disable use of the facility service using the mobile terminal corresponding to the visitor in response to an exit detection signal of the visitor from the facility.

13. The use control apparatus according to claim 12,
wherein, in the process of executing control to enable use of the service in the facility, the processor controls to permit a login for the visitor to start use of the service in the facility, and
in the process of executing control to disable use of the service in the facility, the processor controls to prohibit the login.
